(19) United States
(12) Patent Application Publication
(10) Pub. No.: US 2015/0248147 A1
(43) Pub. Date: Sep. 3, 2015

(54) HOLDING ASSEMBLY

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: YU-MING XIAO, Wuhan (CN); LIANG-CHIN WANG, New Taipei (TW); ZAN LI, Wuhan (CN); XIAO-FEI ZHOU, Wuhan (CN)

(21) Appl. No.: 14/524,819

(22) Filed: Oct. 27, 2014

(30) Foreign Application Priority Data
Feb. 28, 2014 (CN) 201410070819.5

(51) Int. Cl. G06F 1/18

(52) U.S. Cl. CPC G06F 1/187

(57) ABSTRACT

An enclosure assembly includes a base, and a bracket. The base includes two side plates parallel to each other and two installation boards. Each of the two installation boards is attached to each of the two side plates and defining a pivot hole and a rotating slot. The bracket is configured to receive a plurality of data storage devices and includes a pivot post and a rotating post corresponding to each installation board. The pivot post is pivotably engaged in the pivot hole. The rotating post is engaged in the rotating slot and is rotatable about the pivot post relative to the base along the rotating slot, so that there is different angle defined between the bracket and the base.

### CROSS-REFERENCE TO RELATED APPLICATIONS

This application claims priority to Chinese Patent Application No. 201410070819.5 filed on Feb. 28, 2014, the contents of which are incorporated by reference herein.

### FIELD

The subject matter herein generally relates to holding assemblies.

### BACKGROUND

Electronic devices, such as computers, include a plurality of data storage devices. The data storage devices may be hard disk drives, floppy disks, and so on.

### BRIEF DESCRIPTION OF THE DRAWINGS

Implementations of the present technology will now be described, by way of example only, with reference to the attached figures.

FIG. 1 is an exploded, isometric view of a holding assembly and two data storage devices.

FIG. 2 is an isometric view of an installation board of the holding assembly of FIG. 1.

FIG. 3 is an isometric view of a bracket of the holding assembly of FIG. 1.

FIG. 4 is similar to FIG. 3, but viewed from a different angle.

FIG. 5 is exploded, isometric view of the bracket of FIG. 4, and the bracket being cutaway.

FIG. 6 is an assembled view of the holding assembly and the two data storage devices, and the bracket being in a first position.

FIG. 7 is another assembled view of FIG. 6, and the bracket being in a second position.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

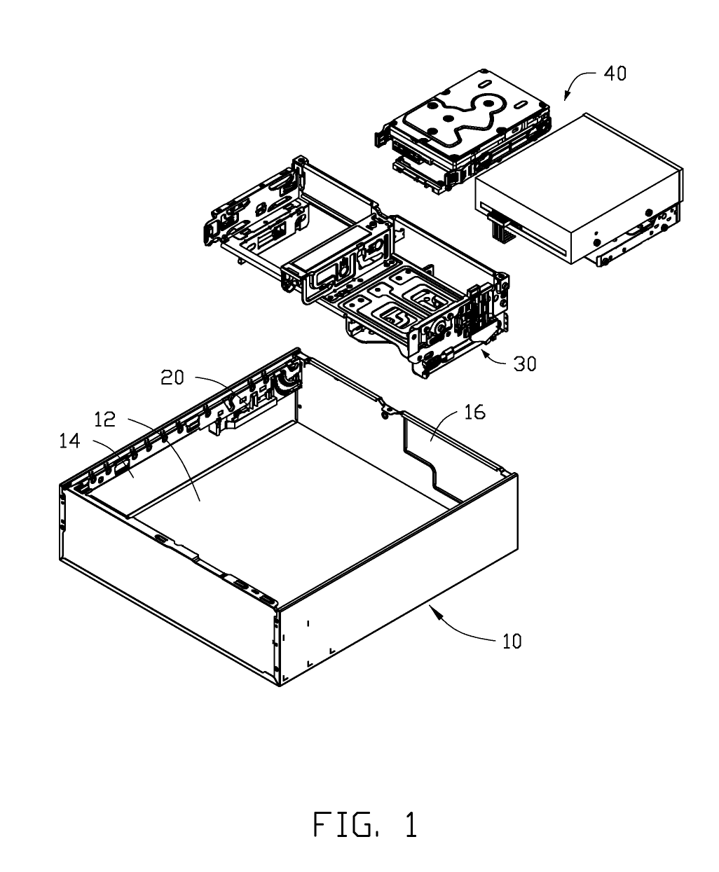

FIG. 1 illustrates a holding assembly for data storage device in accordance with one embodiment. The holding assembly can include a base 10 and a bracket 30 rotatably secured to the base 10. The bracket 30 can receive a plurality of data storage devices 40. In at least one embodiment, the bracket 30 can receive two data storage devices 40, and the two data storage devices 40 have different sizes.

The base 10 can include a bottom plate 12, two side plates 14, and a rear plate 16. The two side plates 14 can extend upwards from opposite edges of the bottom plate 12. The rear plate 16 can extend upwards from a rear edge of the bottom plate 12 and can be coupled to the two side plates 14. In at least one embodiment, the two side plates 14 are substantially parallel with each other and substantially perpendicular to the bottom plate 12, and the rear plate 16 is substantially perpendicular to the bottom plate 12. The base 10 can further include two installation boards 20 attached to the two side plates 14.

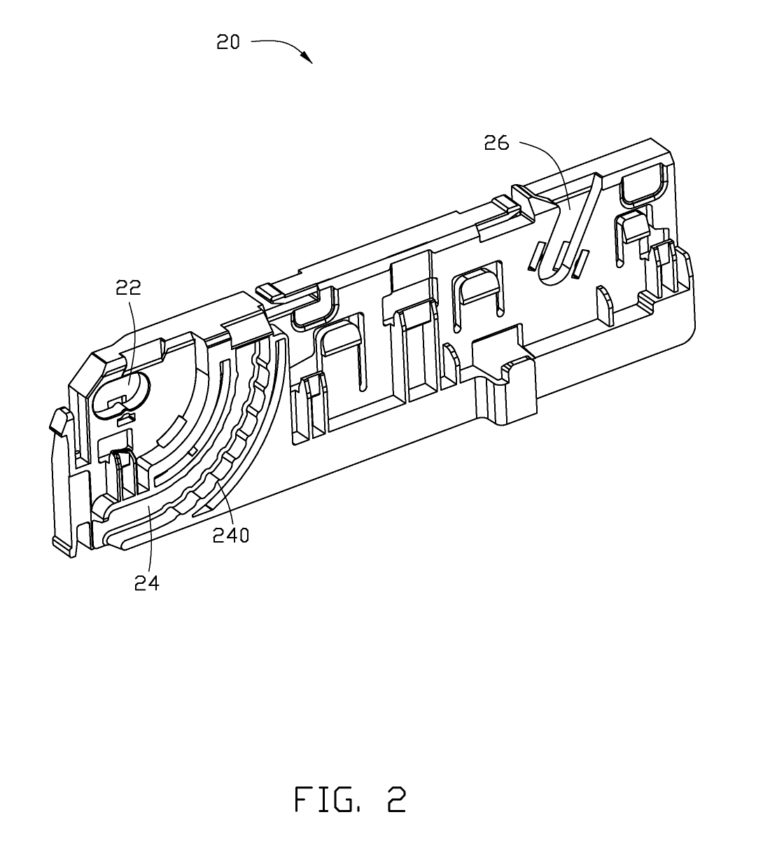

FIG. 2 illustrates that each installation board 20 can define a pivot hole 22, positioning on one corner of the installation board 20. A rotating slot 24 is defined in the installation board 20 and is adjacent to the rotating hole 22. A plurality of ribs 240 protrude from one sidewall of the rotating slot 24 and are equally arranged at the one sidewall. A limiting slot 26 is defined in the installation board 20 and is far from the rotating hole 22. The limiting slot 26 has an extension direction. In at least one embodiment, the installation board 20 is substantially rectangular, the rotating hole 22 is substantially oval-shaped, the rotating slot 24 is substantially arc-shaped, and the limiting slot 26 is substantially U-shaped.

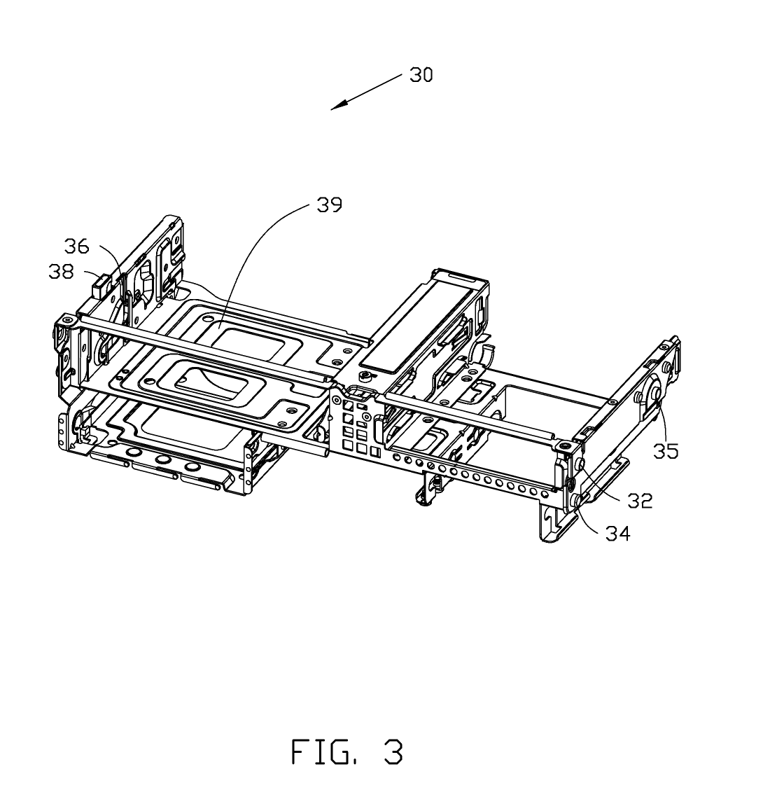

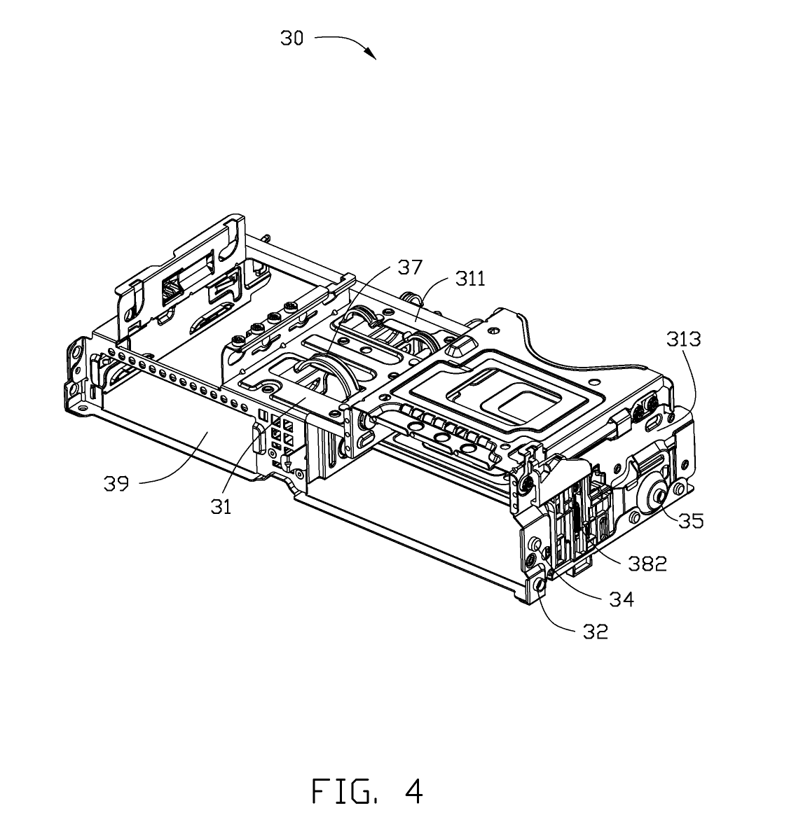

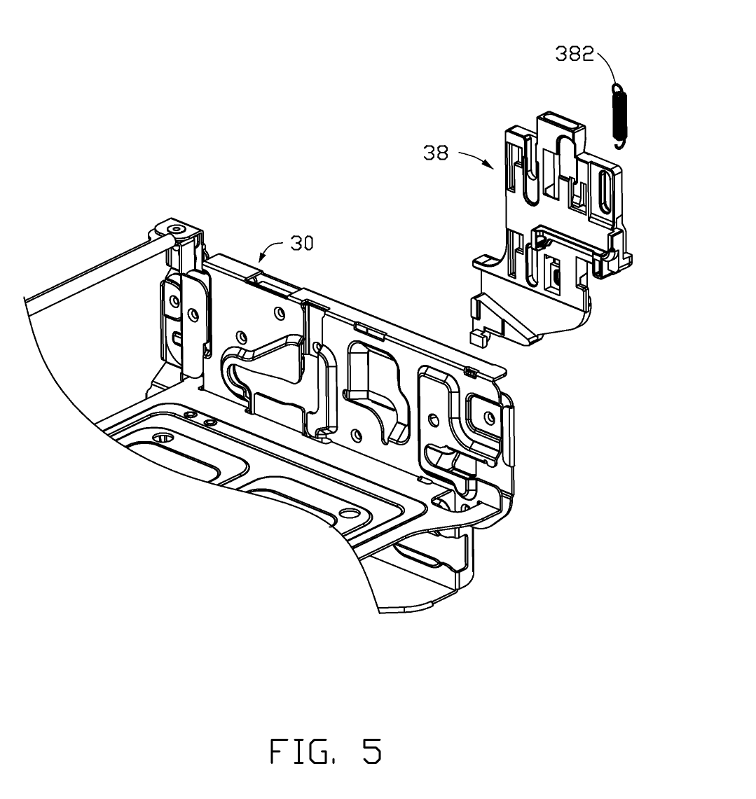

FIGS. 3-5 illustrate that the bracket 30 can include a body 31, a blocking member 38, and a resilient member 382. The body 31 can define two receiving spaces 39 for receiving two data storage devices 40. In at least one embodiment, the two data storage devices 40 have different sizes. The body 31 can include a top wall 311 and two sidewalls 313 connected to the top wall 311. A pivot post 32 protrudes from each of the two sidewalls 313, being adjacent to a front end of the body 31. A rotating post 34 protrudes from each of the two sidewalls 313 and is positioned below corresponding pivot post 32. The pivot post 32 and the rotating post 34 in each sidewall 313 are in a line, and the line is substantially perpendicular to the bottom plate 12 of the base 10. A limiting post 35 is located on each sidewall 313 and is adjacent to a back portion of the body 31.

The blocking member 38 is slidably secured to one sidewall 313 of the body 31, and the resilient member 382 is engaged with the one sidewall 313 and the blocking member 382.

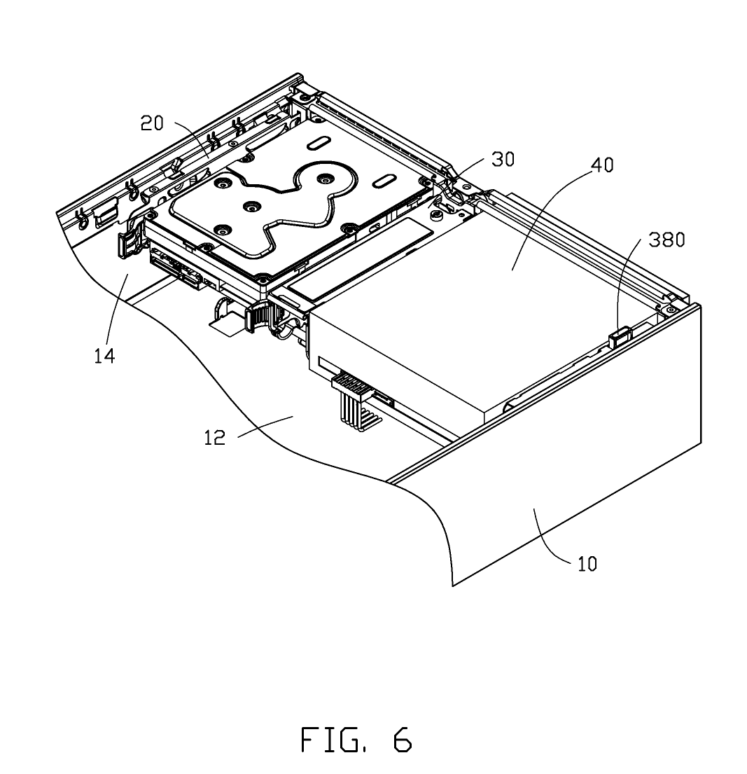

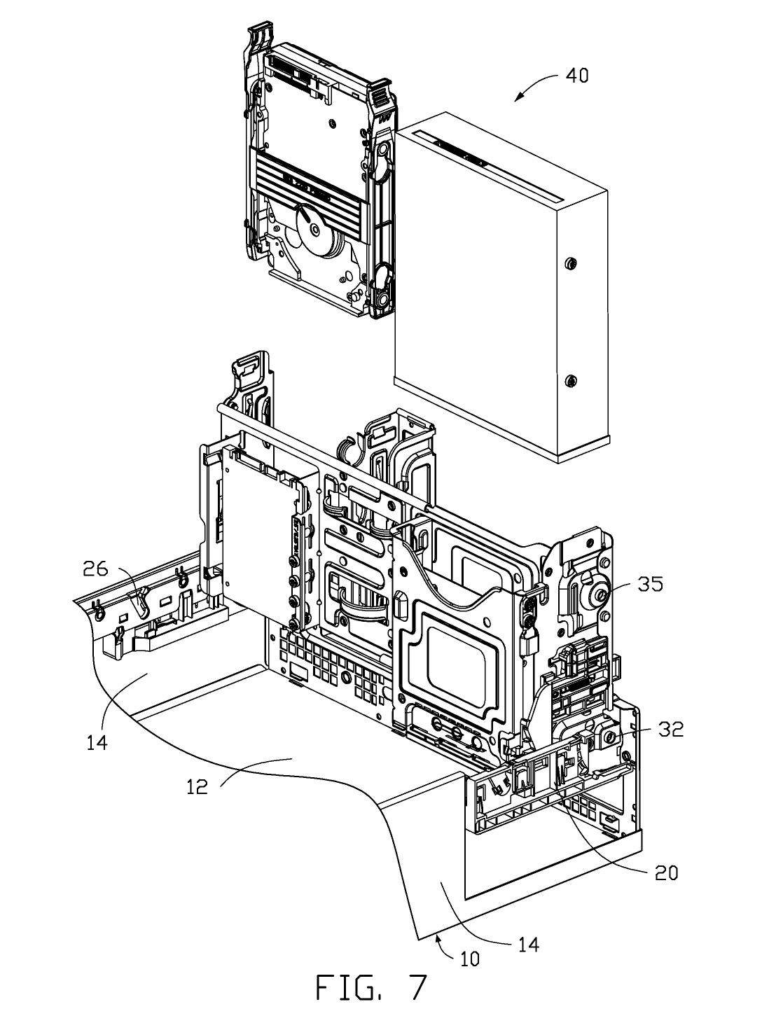

FIGS. 1, 2, 6, and 7 illustrates that in assembly, the two installation boards 20 are respectively secured to the two side plates 14, such as screws, blots, and so on. Each pivot post 32 is engaged into each pivot hole 22, and each rotating post 34 is engaged into each rotating hole 24.

The bracket 30 is rotatable about the pivot posts 32 relative to the base 10 between a first position and a second position. In the first position, the line extending through the pivot post 32 and the rotating post 34 is substantially perpendicular to the bottom plate 12, and the limiting post 35 is engaged in a bottom portion of the limiting slot 26. In the second position, the line is substantially parallel with the bottom plate 12, and the limiting post 35 is disengaged from the limiting slot 26. The rotating post 34 is rotatable about the pivot post 32 along the rotating slot when the bracket 30 is rotated between the first position and the second position. When the bracket 30 is rotated to a preset angel, the rotating post 34 can be engaged between adjacent ribs 240, to prevent the bracket 30 from being rotated.

When the bracket 30 is located in the second position, the data storage devices 40 can be conveniently inserted into corresponding receiving space 39. Then the bracket 30 is rotated from the second position to the second position, the blocking member 38 can be engaged with the base 10.

The embodiments shown and described above are only examples. Many details are often found in the art such as the other features of a holding assembly. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A holding assembly comprising:
a base comprising two side plates parallel to each other and two installation boards, each of the two installation boards being attached to each of the two side plates and defining a pivot hole and a rotating slot; and
a bracket configured to receive a plurality of data storage devices and comprising a pivot post and a rotating post corresponding to each installation board;
wherein the pivot post is pivotably engaged in the pivot hole, the rotating post is engaged in the rotating slot and is rotatable about the pivot post relative to the base along the rotating slot to adjust angle defined between the bracket and the base.

2. The holding assembly of claim 1, wherein a plurality of ribs is located on one sidewall of the rotating slot, and the rotating post is engaged between two adjacent ribs of the plurality of ribs to prevent the bracket from rotating relative to the base.

3. The holding assembly of claim 1, wherein the rotating slot is substantially arc-shaped.

4. The holding assembly of claim 1, wherein the base further comprises a bottom plate, each installation board defines a limiting slot, the bracket further comprises a limiting post, the limiting post is engaged in a bottom portion of the limiting slot, to prevent the bracket from moving towards the bottom plate.

5. The holding assembly of claim 4, wherein the limiting slot defines an extension direction, and an acute angle is defined between the extension direction and the bottom plate.

6. The holding assembly of claim 4, wherein the limiting slot is substantially U-shaped.

7. A holding assembly comprising:
a base comprising a bottom plate, two side plates extending from the bottom plate and two installation boards, each of the two installation boards being attached to each of the two side plates and defining a pivot hole and a rotating slot; and
a bracket configured to receive a plurality of data storage devices and comprising a pivot post and a rotating post corresponding to each installation board, a line extending through the pivot post and the rotating post;
wherein the pivot post is engaged in the pivot hole, the rotating post is rotatably engaged in the rotating slot and the bracket is rotatable about the pivot post relative to the base between a first position and a second position;
in the first position, the line is substantially perpendicular to the bottom plate; and
in the second position, the line is substantially parallel with the bottom plate.

8. The holding assembly of claim 7, wherein a plurality of ribs is located on one sidewall of the rotating slot, and the rotating post is engaged between two adjacent ribs of the plurality of ribs to prevent the bracket from rotating relative to the base.

9. The holding assembly of claim 7, wherein the rotating slot is substantially arc-shaped.

10. The holding assembly of claim 7, wherein each installation board defines a limiting slot, the bracket further comprises a limiting post, the limiting post is engaged in a bottom portion of the limiting slot, to prevent the bracket from moving towards the bottom plate.

11. The holding assembly of claim 10, wherein the limiting slot has an extension direction, and an acute angle is defined between the extension direction and the bottom plate.

12. The holding assembly of claim 10, wherein the limiting slot is substantially U-shaped.

13. A holding assembly comprising:
a base comprising a bottom plate, two side plates extending from the bottom plate, and two installation boards, each of the two installation boards being attached to each of the two side plates and defining a pivot hole and a limiting slot; and
a bracket configured to receive a plurality of data storage devices and comprising a pivot post and a limiting post corresponding to each installation board;
wherein the pivot post is engaged in the pivot hole, and the bracket is rotatable about the pivot posts relative the base between a first position and a second position;
in the first position, the limiting post is engaged in the limiting slot; and
in the second position, the limiting post is disengaged from the limiting slot.

14. The holding assembly of claim 13, wherein the limiting slot defines an extension direction, and an acute angle is defined between the extension direction and the bottom plate.

15. The holding assembly of claim 13, wherein the limiting slot is substantially U-shaped.

16. The holding assembly of claim 13, wherein each installation board further define a rotating slot, the bracket further comprises a rotating post corresponding to the rotating slot, and the rotating post is rotatable along the rotating slot.

17. The holding assembly of claim 16, wherein a plurality of ribs is located on one sidewall of the rotating slot, and the rotating post is engaged between two adjacent ribs of the plurality of ribs to prevent the bracket from rotating relative to the base.

18. The holding assembly of claim 16, wherein the rotating slot is substantially arc-shaped.

19. The holding assembly of claim 16, wherein a line extends through the pivot post and the rotating post; when the bracket is located in the first position, the line is substantially perpendicular to the bottom plate, and when the bracket is located in the second position, the line is substantially parallel with the bottom plate.
